(19) United States
(12) Patent Application Publication
(10) Pub. No.: US 2006/0051985 A1
(43) Pub. Date: Mar. 9, 2006

(54) Ultra-thin flexible electronic device

(75) Inventors: Ming-Daw Chen, Hsinchu City (TW); Chang-Ho Liou, Shetou Township (TW); Jih-Fon Huang, Jhubei City (TW)

Correspondence Address: BRUCE H. TROXELL;SUITE 1404, 5205 LEESBURG PIKE, FALLS CHURCH, VA, 22041, US

(73) Assignee: Industrial Techonology Research Institute

(21) Appl. No.: 10/984,905

(22) Filed: Nov. 10, 2004

(30) Foreign Application Priority Data
Sep. 3, 2004 (TW) 93213986

(51) Int. Cl. H01R 12/00

(52) U.S. Cl. 439/67

(57) ABSTRACT

An ultra-thin flexible electronic device of the invention, comprises: a flexible printed circuit board (FPC), having a circuit layout arranged thereon; an input element, electrical-connected to the FPC for setting up a data; a display, electrical-connected to the FPC for displaying the data; a power supply, connected to the FPC for providing electricity to the FPC, the input element and the display through the circuit layout; a thin substrate, being disposed to lay over the FPC and the power supply; and a polymer film; wherein the FPC, the input element, the display, the power supply and the thin substrate are all flexible.

### FIELD OF THE INVENTION

The present invention relates to an ultra-thin flexible electronic device, and more particularly, to an ultra-thin flexible electronic device composed of flexible components enabling the device to be suitable for attaching the same on all kinds of curved surface.

### BACKGROUND OF THE INVENTION

Most electronic devices are provided with some kind of human-machine-interface for enabling the electronic devices to interact with users. For example, personal digital assistant (PDA) is the typical electronic device equipped with a liquid crystal display (LCD) for displaying information to users. Moreover, some electronic devices even equip with input component integrally-formed with the display component, such as the touch screen, which enables users to input data into the electrical components constructed inside the electronic device.

In general, the display component is the heaviest component inside any electronic device. For instance, the LCD is substantially composed of a plurality of sophisticated and hefty substrates. In a conventional LCD fitted inside an electronic device, the exterior substrate made of glass is already a pretty heavy structure while comparing with other electrical components of the electronic device. If a PDA uses LCD for displaying, the PDA will become bulky since the LCD itself is already heavy enough.

In addition, the LCD is also the most fragile of all the electrical components inside an electronic device. As was disclosed above, the LCD is substantially composed of a plurality of sophisticated and hefty substrates. If any one of the substrate is damaged, not only the LCD itself, but also in consequence even the electronic device will not function normally. In this regard, if the LCD of an electronic device is overly bended or being compressed excessively that is damaged, the electronic device will not function. In a real-life circumstance, a PDA is accidentally dropped by its user such that the dropping and crashing on the floor exerts a force on the LCD thereof and thus damages the LCD causing the malfunction of the PDA.

Moreover, since price tags are heavily used in department store and wholesale store, it is in great demand to have a flexible electronic device capable of being attached on all kinds of curved surface for replacing the use of paper price tags under the consideration of cost-saving and environmental conservation. By using the flexible electronic device for replacing the paper price tags, not only the price of merchandise can be changed in real time basing on the change of exchange rate or the current promotion discount, but also the consumption of paper can be saved. In addition, the use of flexible electronic device enables the achieving of e-operation and logistics integration. Also the flexible electronic device has the advantage of portability and light-weight that can be used as the replacement of wrist-watch or timer, etc.

### SUMMARY OF THE INVENTION

It is the primary object of the invention to provide an ultra-thin flexible electronic device composed of flexible components enabling the device to be suitable for attaching the same on all kinds of curved surface.

To achieve the above object, the ultra-thin flexible electronic device of the invention comprises: a flexible printed circuit board (FPC), having a circuit layout arranged thereon; an input element, electrical-connected to the FPC for setting up a data; a display, electrical-connected to the FPC for displaying the data; a power supply, connected to the FPC for providing electricity to the FPC, the input element and the display through the circuit layout; a thin substrate, being disposed to lay over the FPC and the power supply; and a polymer film; wherein the FPC, the input element, the display, the power supply and the thin substrate are all flexible.

In a preferred embodiment of the invention, the ultra-thin flexible electronic device of the invention is a watch or time indicator having a total thickness of less than 1 mm, which further comprises: an oscillator (OSC), connected to the FPC for timing; a polymer film, arranged on the surface of the ultra-thin flexible electronic device; a pasting element, for attaching the device on a surface; wherein the power supply is a lithium polymer battery.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a sectional view of an ultra-thin flexible electronic device according to the present invention.

FIG. 2 is a partial top view of an ultra-thin flexible electronic device according to the present invention.

FIG. 3 is a partial side view of an ultra-thin flexible electronic device according to the present invention.

FIG. 4A to FIG. 4C are schematic illustrations showing an ultra-thin flexible electronic device of the present invention in different deformation states.

FIG. 5 is a schematic illustration showing an ultra-thin flexible electronic device according to a preferred embodiment of the present invention.

### DESCRIPTION OF THE PREFERRED EMBODIMENT

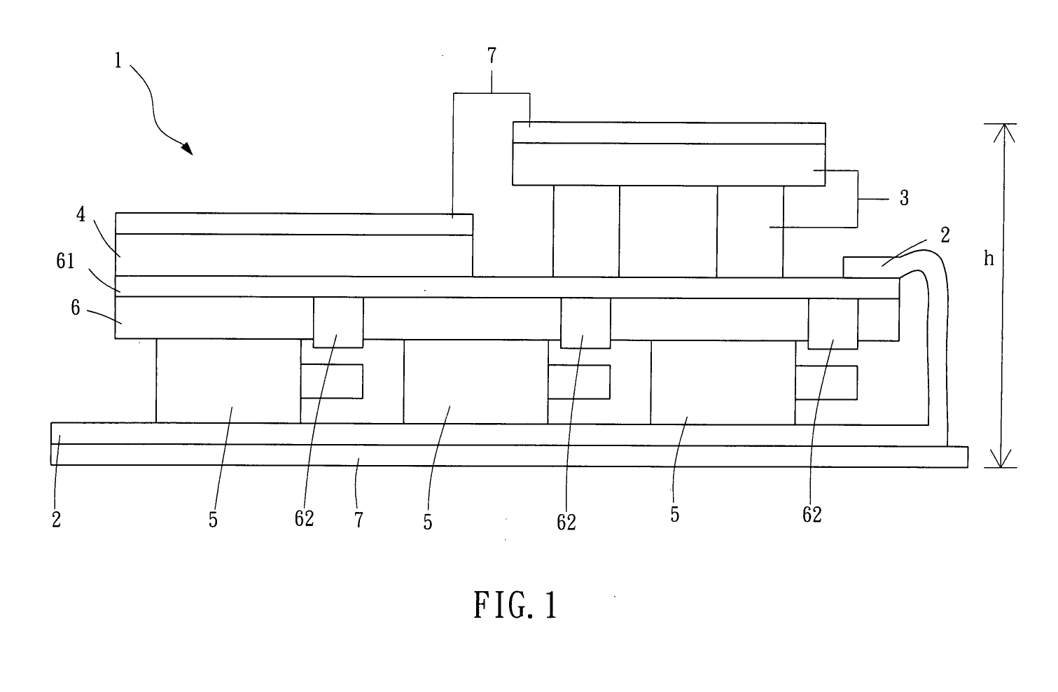

As seen in FIG. 1, the ultra-thin flexible electronic device 1 comprises: a flexible printed circuit board (FPC) 2, having a circuit layout arranged thereon; a metal foil 6, having a thin substrate 61 arranged thereon and a plurality of electrodes 62 arranged therein; an input element 3, electrical-connected to the FPC 2 through the plural electrodes 62 for setting up a data; a display 4, electrical-connected to the FPC 2 through the plural electrodes 62 for displaying the data; a power supply 5, connected to the FPC 2 through the plural electrodes 62 for providing electricity to the FPC 2, the input element 3 and the display 4 through the circuit layout; and a polymer film 7, covering the surface of the flexible electronic device 1 for protecting the same; wherein the metal foil 6 and the thin substrate 61 is disposed to lay over the FPC 2 and the power supply 5.

In addition, the improvements disclosed in the ultra-thin flexible electronic device 1 are that the FPC 2, the input element 3, the display 4, the power supply 5, the metal foil 6 and the thin substrate 61 are all flexible, and the overall thickness h of the device 1 is less than 1 mm.

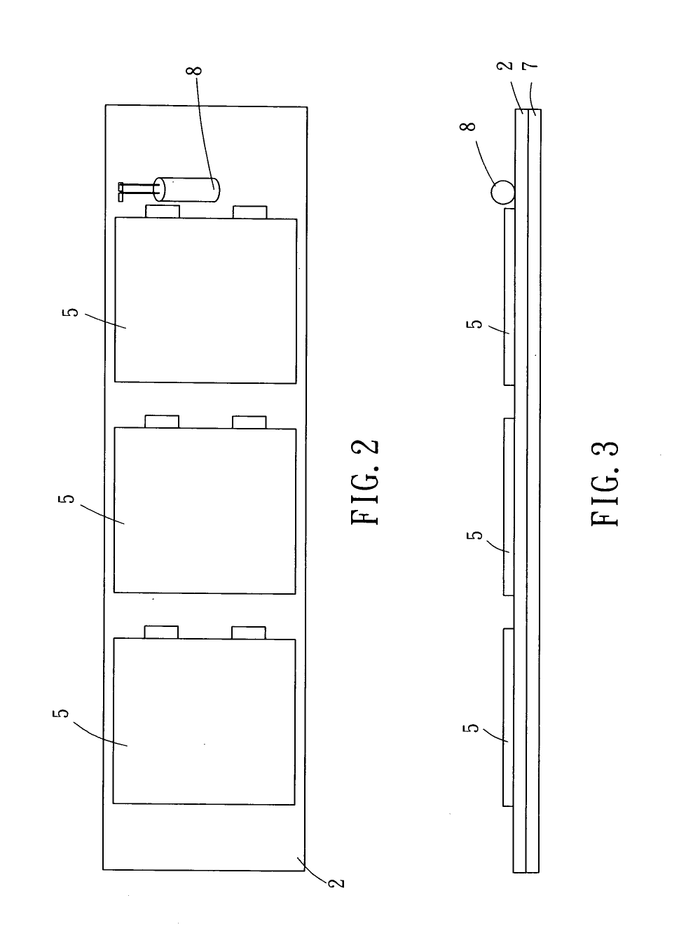

Please refer to FIG. 2 and FIG. 3, which are respectively a partial top view and a partial side view of an ultra-thin flexible electronic device according to the present invention. Except for the power supply 5, the FPC 2, and the polymer film 7, the device 1 seen in FIG. 2 and FIG. 3 further comprises: an oscillator 8, electrical-connected to the FPC 2 for timing while the device 1 is a watch or time indicator; and a pasting element 9, for attaching the device 1 on any curved or slick surface of an object 10 for improving the convenience and variability of the device 1; wherein the oscillator 8 can be avoided while accurate timing is not required, and the pasting element 9 can be a convenient glue, a Velcro strip or a magnetic material.

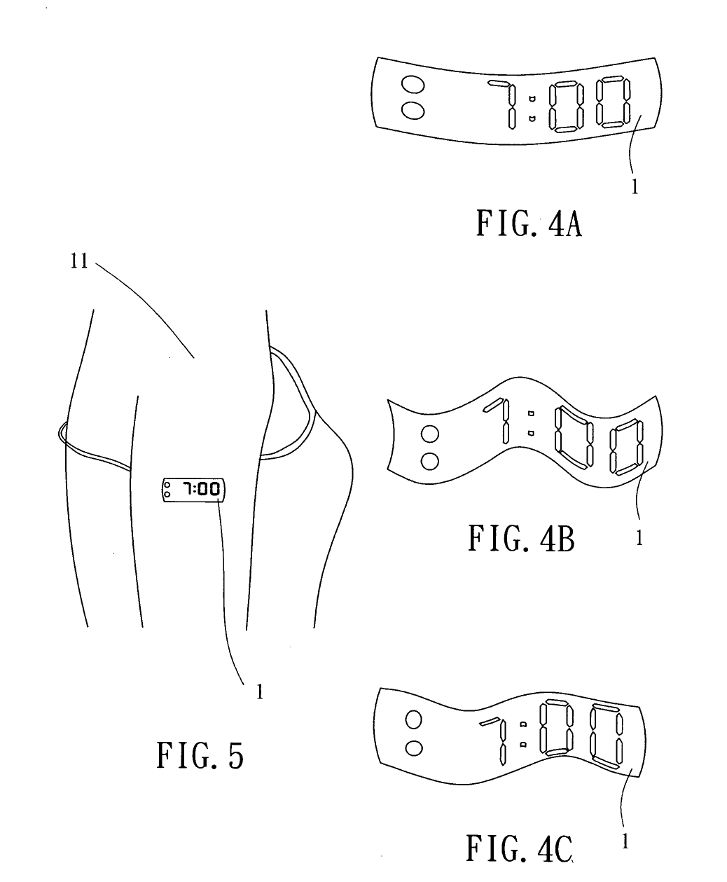

Please refer to FIG. 4A to FIG. 4C, which are schematic illustrations showing an ultra-thin flexible electronic device of the present invention in different deformation states. The ultra-thin flexible electronic device 1 of the invention is capable of maintaining its normal function while it is bended at will, such that it can attach itself onto the surface of all kind of object.

Please refer to FIG. 5, which is a schematic illustration showing an ultra-thin flexible electronic device according to a preferred embodiment of the present invention. The ultra-thin flexible electronic device 1 disclosed in FIG. 5 is a time indicator which can be attached on human skin 11 by a convenient glue (not shown in the figure). Moreover, the ultra-thin flexible electronic device 1 not only is a light-weight and small device that is easy to carry, but also is composed of ultra-thin flexible components so that it can be attached smoothly on a surface of any curvature and any material.

In another preferred embodiment of the invention, the polymer film laying over the input element and the display is integrally formed, that is, it is seamless between the input element and the display for improving the surface smoothness of the ultra-thin flexible electronic device of the invention that is also capable of blocking any outside contaminants, such as moisture and dust.

In yet another preferred embodiment of the invention, the circuit layout can be arranged on the display. In this regard, not only the FPC can do without the disposition of the circuit layout, but also the disposition of metal foil can be voided since it is being used only for conducting electricity.

In the preferred embodiment of the invention, the display of the invention can be an active display or a passive display. If an active display is being used in the ultra-thin flexible electronic device of the invention as the display, it can be an organic light-emitting diode (OLED) or an active matrix liquid crystal display (AMLCD). In addition, if a lithium polymer battery is used as the power supply of the invention, it can be a primary battery or a rechargeable battery. Furthermore, the FPC can be a chip on film (COF), and the thin substrate can be a thin glass substrate or a thin plastic substrate. The thin substrate also can be made of any suitable materials as it should be.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An ultra-thin flexible electronic device, comprising:
a flexible printed circuit board (FPC);
an input element, electrical-connected to the FPC for setting up a data;
a display, electrical-connected to the FPC for displaying the data;
a power supply, connected to the FPC for providing electricity to the FPC, the input element and the display; and
a thin substrate, being disposed to completely lay over the FPC and the power supply;
wherein the FPC, the input element, the display, the power supply and the thin substrate are all flexible.

2. The device of claim 1, wherein the device further comprises an oscillator (OSC), being electrical-connected to the FPC for providing accurate timing.

3. The device of claim 1, wherein a polymer film is disposed on the surface of the ultra-thin flexible electronic device, and the polymer film is substantially a polyethylene terephthalate (PET)

4. The device of claim 3, wherein the polymer film is integrally formed.

5. The device of claim 1, wherein a circuit layout is arranged on the flexible printed circuit board (FPC), the circuit layout being connected to the power supply enabling the power supply to provide electricity to the FPC, the input element, and the display.

6. The device of claim 1, wherein a circuit layout is arranged on the display, the circuit layout being connected to the power supply enabling the power supply to provide electricity to the FPC, the input element, and the display.

7. The device of claim 1, wherein the display is an active display.

8. The device of claim 7, wherein the active display is substantially an organic light-emitting diode (OLED).

9. The device of claim 7, wherein the active display is substantially an active matrix liquid crystal display (AMLCD).

10. The device of claim 1, wherein the display is substantially a passive display.

11. The device of claim 1, wherein the power supply is substantially a polymer battery.

12. The device of claim 11, wherein the polymer battery is substantially a lithium battery.

13. The device of claim 1, wherein the device further comprises a pasting element enabling the device to be able to attach itself on a surface.

14. The device of claim 13, wherein the pasting element is substantially a convenient glue.

15. The device of claim 13, wherein the pasting element is substantially a Velcro strip.

16. The device of claim 13, wherein the pasting element is substantially a magnetic material.

17. The device of claim 1, wherein the total thickness of the device is less than 1 mm.

18. The device of claim 1, wherein the flexible printed circuit board (FPC) is substantially a chip on film (COF).

19. The device of claim 1, wherein a metal foil is arranged between the thin substrate and the power supply.
